(19) United States
(12) Patent Application Publication
(10) Pub. No.: US 2012/0197624 A1
(43) Pub. Date: Aug. 2, 2012

(54) SYSTEM AND METHOD FOR MANAGING A STORAGE ARRAY USING SIMULATION

(76) Inventors: VISHWANATH HAWARGI, Bangalore (IN); Gopakumar Ambat, Bangalore (IN); Giribabu Balaraman, Bangalore (IN)

(21) Appl. No.: 13/015,601

(22) Filed: Jan. 28, 2011

(51) Int. Cl. G06F 9/455

(52) U.S. Cl. 703/21

(57) ABSTRACT

A system and method for managing a storage array using simulation is disclosed. In one example embodiment, in a computer implemented method for managing a storage array using simulation, a virtual storage array, including a plurality of virtual storage array objects, associated with a physical storage array is generated using a storage array simulator residing in a storage array management server. Then, configuration changes are performed on the virtual storage array to form a desired virtual storage array to simulate presence of changed storage array without underlying hardware using the storage array simulator. Performance of the formed desired virtual storage array is determined without the underlying hardware of the storage array using the storage array simulator. The desired virtual storage array including the plurality of virtual storage array objects is uploaded to the associated physical storage array based on the outcome of determination.

### TECHNICAL FIELD

The present invention relates generally to storage array management, and more particularly to managing a storage array using simulation.

### BACKGROUND

A storage array, such as a storage area network (SAN) array has many advantages and typically, improves functionality of accessing stored data in computer networks compared to other enterprise data storage solutions. However, the SAN array can be expensive, and thus cost considerations may come into the picture when enterprises are considering adopting a SAN array as a solution to their data storage needs.

Further, managing the storage array, generally, involves disk allocations, volume creations, volume mappings, users to volume accessibility settings and so on. For an administrator, these tasks can be very time consuming and can require a lot of planning. Furthermore, these tasks may cause considerable downtime, which the administrator has to take into account when managing the storage array. Moreover, the administrator has to be well knowledgeable about the underlying storage array technology as these technologies deployed in the storage array can significantly vary from vendor-to-vendor or from the same vendor itself.

Many existing storage array management solutions try to resolve storage array management issues using user friendly interactive modules. However, these solutions depend on existing available hardware. This dependency on the existing available hardware may restrict amount of testing the administrator can perform to determine a needed storage array configuration that meets the requirement. Typically, this requires the administrator to work on an existing storage array setup without significantly affecting the existing configuration, which can sometimes require an intelligent guess by the administrator to configure and implement any of the modifications and enhancements to the storage array.

In such a constrained scenario, it can be seen that the administrator has very few options to try out different configurations to obtain a desired configuration for the storage array. This process can result in implementing a less than desired storage array configuration. For example, a thin provisioning can go a long way in assisting the administrator in provisioning right sized volumes, storage across hosts, however, the administrator can err on the side of over allocating resources than under allocation, which may result in a less than desired storage array configuration.

For example, in a cloud computing scenario, this problem may get even more compounded as the cloud clients present a multi-tenancy scenario, which can require provisioning any new storage allocation requests without disturbing existing storage array configurations. Provisioning storage array allocation requests in such complex environments can be difficult.

### SUMMARY

A system and method for managing a storage array using simulation is disclosed. In accordance with one aspect of the present invention, in a computer implemented method for managing a storage array using simulation, a virtual storage array associated with a physical storage array is generated using a storage array simulator residing in a storage array management server. The virtual storage array includes a plurality of virtual storage array objects. Configuration changes are performed on the virtual storage array to form a desired virtual storage array to simulate presence of changed storage array without underlying hardware using the storage array simulator. Then, performance of the formed desired virtual storage array is determined without the underlying hardware of the storage array using the storage array simulator. The desired virtual storage array including the plurality of virtual storage array objects is uploaded to the associated physical storage array based on the outcome of the determination.

In accordance with another aspect of the present invention, a system for managing a storage array using simulation includes one or more storage arrays, a storage array simulator residing in a storage array management server and a TCP/IP network switch. The storage array simulator includes a performance analyzer, a configuration analyzer and an upload/download module and the storage array management server includes a display device. The one or more storage arrays and the storage array management server are coupled via the TCP/IP network switch.

The storage array simulator generates a virtual storage array, including a plurality of virtual storage array objects, associated with a physical storage array residing in the storage array management server. The storage array simulator also performs configuration changes on the virtual storage array using the display device to form a desired virtual storage array to simulate presence of changed one of the one or more storage arrays without underlying hardware using the configuration analyzer residing in the storage array simulator.

The storage array simulator then determines performance of the formed desired virtual storage array without the underlying hardware of the associated storage array using the performance analyzer residing in the storage array simulator. The storage array simulator uploads the desired virtual storage array including the plurality of virtual storage array objects to the associated physical storage array based on the outcome of the determination using the upload/download module residing in the storage array simulator.

The system also includes one or more application servers coupled to the one or more storage arrays via a cloud computing network and the TCP/IP network switch. The storage array simulators in the one or more application servers associated with the cloud computing network determines whether the uploaded generated set of ordered physical storage array specific commands associated with the formed desired virtual storage array in the associated one of the one or more physical storage arrays is provisioned to their requirements.

In accordance with yet another aspect of the present invention, a non-transitory computer-readable storage medium for managing a storage array using simulation, having instructions that, when executed by a computing device causes the computing device to perform the method as described above.

The methods, and systems disclosed herein may be implemented in any means for achieving various aspects, and other features will be apparent from the accompanying drawings and from the detailed description that follows.

### BRIEF DESCRIPTION OF THE DRAWINGS

Various embodiments are described herein with reference to the drawings, wherein:

FIG. 1 illustrates a flow diagram for managing a storage array using simulation, according to an embodiment;

FIG. 2 illustrates another flow diagram for managing a storage array using simulation, according to an embodiment;

FIG. 3 is a block diagram showing managing of one or more storage arrays using a storage array management server including a storage array simulator, according to an embodiment; and

FIG. 4 illustrates a block diagram of a configured XML representation of a virtual storage array corresponding to the physical storage array using the storage array simulator of FIG. 3 and the simulation methodology illustrated in FIG. 1, according to an embodiment.

The drawings described herein are for illustration purposes only and are not intended to limit the scope of the present invention in any way.

### DETAILED DESCRIPTION

A system and method for managing a storage array using simulation is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

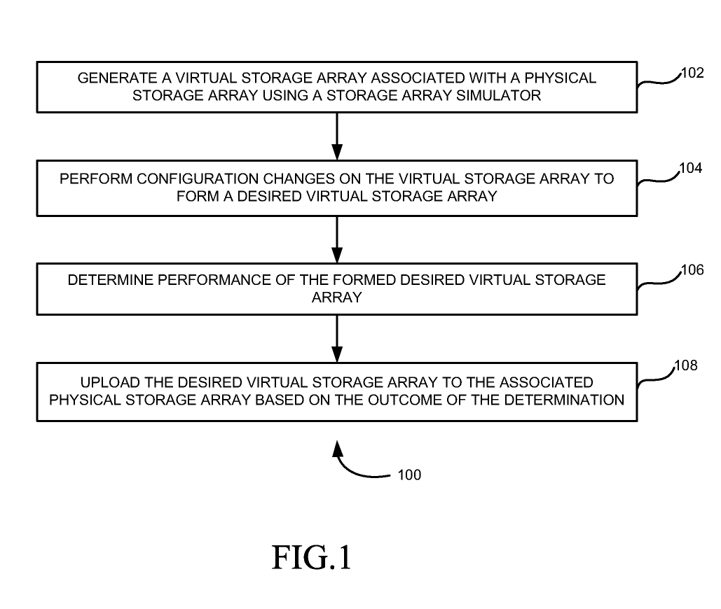

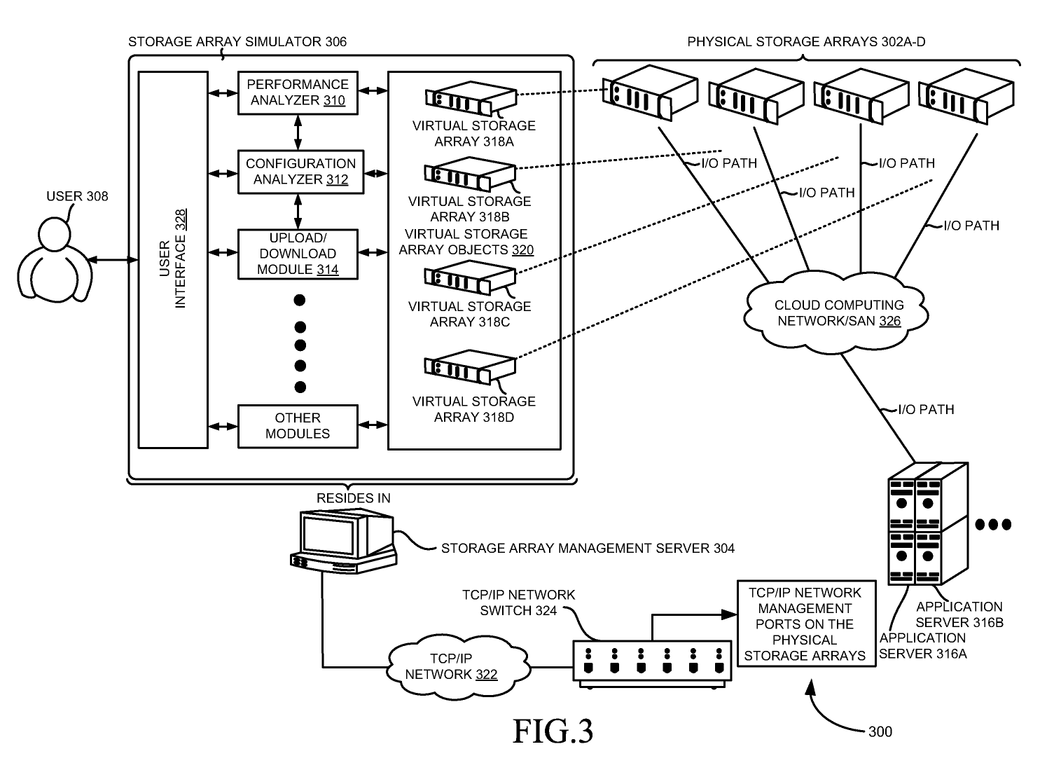

FIG. 1 illustrates a flow diagram 100 of an exemplary computer implemented method for managing a storage array using simulation, according to an embodiment. For example, the storage array may be a storage area network (SAN) array. At step 102, a virtual storage array associated with a physical storage array (e.g., one of the physical storage arrays 302A-D of FIG. 3) is generated using a storage array simulator (e.g., the storage array simulator 306 of FIG. 3) residing in a storage array management server (e.g., the storage array management server 304 of FIG. 3). In one embodiment, the virtual storage array is generated using a storage array simulator residing in the storage array management server by an administrator. In another embodiment, a software or a hardware component can be configured to act as the administrator. The virtual storage array includes a plurality of virtual storage array objects. In one embodiment, a data representation of the virtual storage array including the plurality of virtual storage array objects is generated using the storage array simulator.

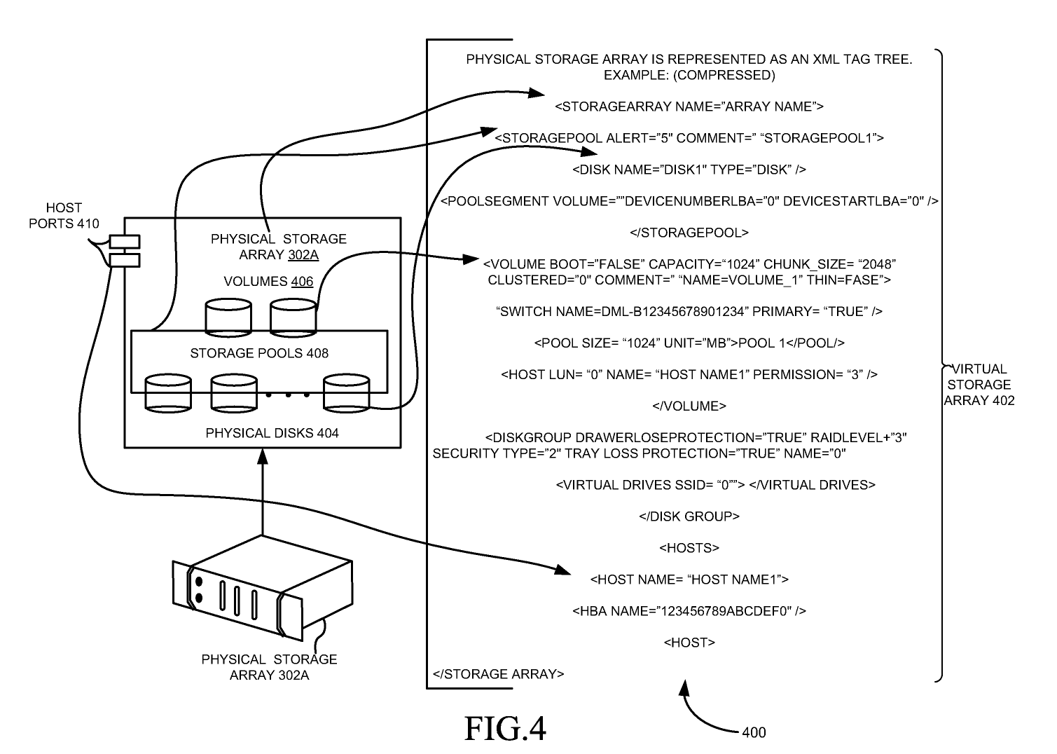

During generating the data representation of the virtual storage array including the plurality of virtual storage array objects, metadata (e.g., in an XML format) associated with configuration information of the physical storage array is extracted. The configuration information includes but not limited to physical configuration information, virtual configuration information, utilization information, and synchronous/asynchronous mirroring information. The extracted metadata in the XML format is then loaded and presented as the virtual storage array (e.g., the virtual storage array 402 of FIG. 4) on a display device by the storage array simulator.

At step 104, configuration changes are performed on the virtual storage array to form a desired virtual storage array to simulate presence of changed storage array without underlying hardware using the storage array simulator. The configuration changes include but not limited to creating, editing and deleting users, user list, physical disks, storage pools, virtual volumes, host bus adapters (HBAs), hosts, host accessibility, logical unit number (LUN) masking and LUN mapping associated with the physical storage array.

For example, the configuration changes are performed on the metadata in the XML format associated with the virtual storage array to form the desired virtual storage array. At step 104, performance of the formed desired virtual storage array is determined without the underlying hardware of the storage array using the storage array simulator.

In one embodiment, a trend analysis is performed on the formed desired storage virtual storage array without the underlying hardware of the storage array using the storage array simulator. Then, if needed, based on the outcome of the performed trend analysis, further configuration changes are performed on the metadata in the XML format of the formed desired virtual storage array using the storage array simulator. The steps of performing the trend analysis and performing the further configuration changes are repeated on the metadata in the XML format until the desired virtual storage array is formed.

At step 106, the desired virtual storage array including the plurality of virtual storage array objects is uploaded to the associated physical storage array based on the outcome of the determination. For example, the uploading includes generating a set of ordered physical storage array specific commands. The set of ordered physical storage array specific commands can be executed by a storage management software managing the physical storage array using the metadata in the XML format of the desired virtual storage array using the storage array simulator.

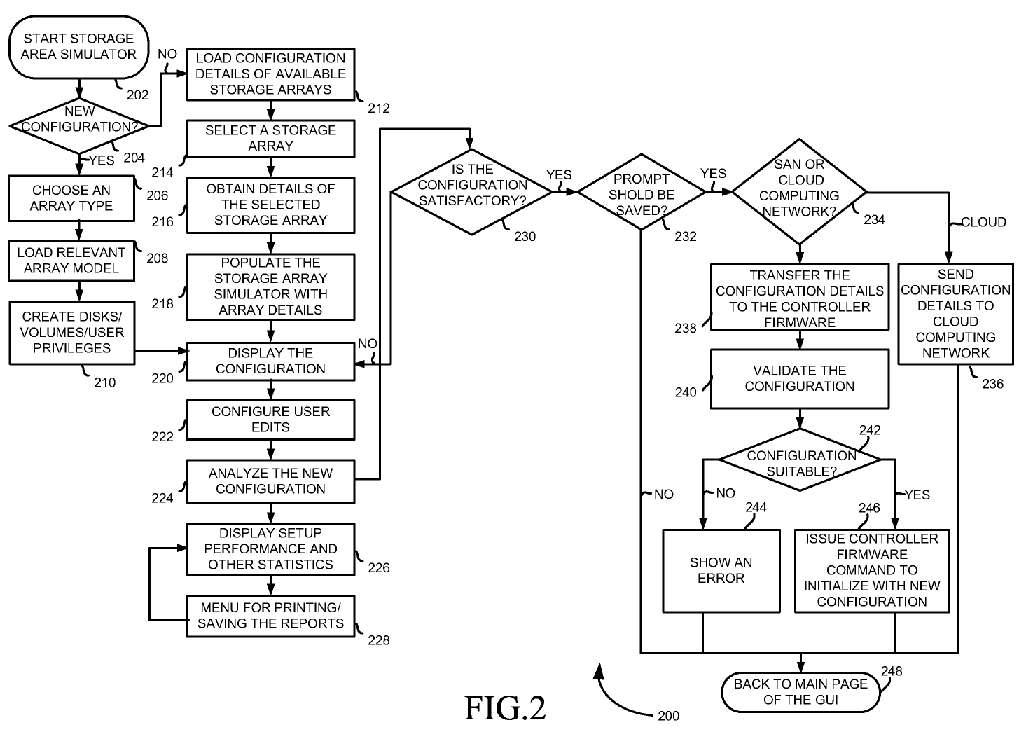

FIG. 2 illustrates another flow diagram 200 for managing a storage array using simulation, according to an embodiment. At step 202, a storage array simulator (e.g., the storage array simulator 306 of FIG. 3) is started. At step 204, it is determined whether a user (e.g., the user 308 of FIG. 3) can work on an existing storage array or a new configuration needs to be created. If it is determined that a new configuration needs to be created, step 206 is performed, else step 212 is performed. At step 206, an array type is chosen by the user. At step 208, a relevant array model is loaded. At step 210, disks, volumes, user privileges and the like are created by the user. The simulation then proceeds at step 220.

At step 212, configuration details (e.g., configured hosts, LUNs exposed, volumes provisioned, quality of service (QoS) policies attached to the volumes, etc.) of the existing storage arrays are loaded. For example, data from physical storage arrays are loaded. At step 214, a storage array is selected. At step 216, details of the selected storage array is obtained. At step 218, the storage array simulator is loaded with the details of the selected storage array. At step 220, the configuration is displayed. At step 222, user edits are configured. At step 224, the new configuration is analyzed. At step 226, setup performance and other statistics are displayed. For example, there can be performance issues due to wrong storage controller ownership and mismatched I/O paths.

At step 228, performance reports are printed or saved. To tune in all the performance issues, at step 230, it is determined whether the configuration is satisfactory. If it is determined that the configuration is satisfactory, step 232 is performed, else, the simulation is cancelled and is returned to the main page of a graphical user interface (GUI) at step 248. At step 232, it is determined whether the prompt should be saved. If it is determined so, step 234 is performed, else the simulation is returned to the main page of the GUI at step 248.

At step 234, it is determined whether the storage array forms a part of a cloud computing network or a SAN. If the storage array forms a part of the cloud computing network, step 236 is performed, where the configuration details are sent to the cloud computing network. The simulation then returns to the main page of the GUI at step 248. If the storage array forms the part of the SAN, step 238 is performed, where the configuration details are transferred to a storage array controller firmware.

At step 240, the configuration is validated by the storage array controller firmware. At step 242, it is determined whether the configuration is stable. If the configuration is not stable, an error is shown in step 244 and then the simulation is returned to the main page of the GUI at step 248. If the configuration is stable, step 246 is performed where controller firmware command is issued to initialize with new configuration. The simulation is then returned to the main page of the GUI. Moreover, in one example embodiment, a non-transitory computer-readable storage medium having instructions that, when executed by a computing device causes the computing device to perform the methods as described above.

FIG. 3 is a block diagram 300 showing managing of one or more storage arrays using a storage array management server 304 including a storage array simulator 306, according to an embodiment. As shown, FIG. 3 includes physical storage arrays 302A-D coupled to the storage array management server 304 including a display device via a TCP/IP network switch 324. The storage array management server 304 includes a storage array simulator 306 which includes a performance analyzer 310, a configuration analyzer 312, and an upload/download module 314.

According to an embodiment of the present invention, an administrator (e.g., the user 308) generates virtual storage arrays 318A-D associated with the physical storage arrays 302A-D through a user interface 328 using the storage array simulator 306. The virtual storage arrays 318A-D are generated using the storage array simulator 306 residing in the storage array management server 304. It can be seen that the virtual storage arrays 318A-D includes the plurality of virtual storage array objects 320.

The storage array simulator 306 performs configuration changes on the virtual storage arrays 318A-D using the display device to form a desired virtual storage array. The desired virtual storage array is formed to simulate presence of changed one of the physical storage arrays 302A-D without underlying hardware using the configuration analyzer 312 residing in the storage array simulator 306. Then, the storage array simulator 306 determines performance of the formed desired virtual storage array without the underlying hardware of the associated one of the physical storage arrays 302A-D using the performance analyzer 310 residing in the storage array simulator 306.

The storage array simulator 306 uploads the desired virtual storage array including the plurality of virtual storage array objects to the associated one of the physical storage arrays 302A-D based on the outcome of the determination using the upload/download module 314 residing in the storage array simulator 306. In one embodiment, the one or more storage arrays is a storage area network (SAN) or a cloud computing network 326. The SAN includes disk arrays, storage array controllers, I/O interfaces and one or more add-on trays.

During generating the virtual storage arrays 318A-N, a data representation of the virtual storage arrays 318A-N including the plurality of virtual storage array objects 320 is generated using the storage array simulator 306. For example, the storage array simulator 306 extracts metadata (e.g., in an XML format) associated with configuration information of the physical storage arrays 302A-D. The configuration information includes but not limited to physical configuration information, virtual configuration information, utilization information, and synchronous/asynchronous mirroring information.

The upload/download module 314 loads up the metadata in the XML format and presents the metadata in the XML format as the virtual storage arrays 318A-D on the display device. The storage array simulator 306 performs configuration changes on the metadata in the XML format associated with the virtual storage arrays 318A-D to form the desired virtual storage array using the configuration analyzer 312.

Then, the storage array simulator 306 performs a trend analysis on the formed desired virtual storage array without the underlying hardware of the associated storage array using the performance analyzer 310. If needed, the storage array simulator 306 performs further configuration changes on the metadata in the XML format of the formed desired virtual storage array using the performance analyzer 310 based on the outcome of the performed trend analysis. The storage array simulator 306 repeats the trend analysis and performs further configuration changes on the metadata in the XML format until the desire virtual storage array is obtained using the performance analyzer 310.

The storage array simulator 306 generates a set of ordered physical storage array specific commands that can be executed by storage management software managing the physical storage arrays 302A-D using the metadata in the XML format of the desired virtual storage array. Then, the storage array simulator 306 uploads the generated set of ordered physical storage array specific commands to the physical storage arrays 302A-D using the upload/download module 314.

Also, as shown in FIG. 3, application servers 316A-N are coupled to the physical storage arrays 302A-D via the cloud computing network 326 and the TCP/IP network switch 324. The storage array simulator 306 in the one or more application servers 316A-N associated with the cloud computing network 326 determines whether the uploaded generated set of ordered physical storage array specific commands associated with the formed desired virtual storage array in the associated one of the one or more physical storage arrays 302A-D is provisioned to their requirements.

Thus, the storage array simulator 306 virtually configures the one or more storage arrays to specific needs and then saves the configuration. The changed configuration is then loaded to the physical storage arrays 302A-D. Once the configuration is transferred to the physical storage arrays 302A-D, the storage array simulator 306 provides a mechanism to setup the configuration in the physical storage arrays 302A-D.

It can be noted that the storage array simulator 306 is used not only for ease of provisioning but also as a means of applying any protection/QoS policies to the one or more storage arrays. For example, while creating a new volume in the one or more storage arrays, the storage array simulator 306 can apply volume copy/snapshot policies or any other policies tied to data movement, as part of hierarchical storage management (HSM) and easily transfer onto the one or more storage arrays. This assumes that there exist software/firmware pieces on the one or more storage arrays which have the capability to actually execute these policies.

FIG. 4 illustrates a block diagram 400 of a configured XML representation of a virtual storage array 402 corresponding to the physical storage array 302A using the storage array simulator 306 of FIG. 3 and the simulation methodology illustrated in FIG. 1, according to an embodiment. For example, the metadata of the physical storage array 302A is extracted in an XML format. As shown in FIG. 4, using the physical storage array 302A the virtual storage array 402 including physical disks 404, and volumes 406 in storage pools 408 is generated. Further as shown in FIG. 4, the physical storage array 302A also includes host ports 410. In one embodiment, configuration information including details and properties of each of the objects/parts in the physical storage array 302A is extracted and saved as tokens/tags to populate the metadata in an XML format. The metadata in the XML format represents the virtual storage array 402. The storage array simulator 306 loads the XML file and presents it as the virtual storage array 402 to the storage management software.

The storage array simulator 306 can manage the virtual storage array 402 using the storage management software. When the storage array simulator 306 makes any configuration changes such as adding new disks, specifying new hosts, carving out volumes on disk, enabling snapshots, etc., every configuration change gets updated in the XML file which means that the virtual storage array 402 reflects the configuration changes. The storage array simulator 306 also performs trend analysis and once complete, the XML file is uploaded back to the physical storage array. The storage array simulator 306 breaks the XML file into a set of ordered array specific commands which will then be executed by the storage management software managing the physical storage array 302A.

In various embodiments, the methods and systems described in FIGS. 1 through 4 proposes a staged configuration management for storage arrays. The staged configuration can be later transferred to a physical storage array which is within a private network or onto a cloud computing network. The staged configuration management using the storage array simulator helps to try out different combinations and possibilities to enhance the usage of the SAN without disrupting the physical storage array and existing setup, until a desired configuration is obtained. Since most of the time is spent in modeling the configuration of the storage array offline, downtime that is required to alter the setup is reduced to a great extent. While working on an existing storage array configuration, user will be allowed to either rewrite the entire configuration afresh or to just update the changes that differ from the existing setup.

The above-mentioned methods and systems can also be used by the administrator for futuristic capacity planning. The current utilization and provisioning information of the storage array can be uploaded to the storage array simulator and the administrator can run through a simulation of how data would grow over a period of time and see where new storage resources have to be bought in.

Although the present embodiments have been described with reference to specific example embodiments, it will be evident that various modifications and changes may be made to these embodiments without departing from the broader scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structures and methods may be embodied using transistors, logic gates, and electrical circuits, such as an application specific integrated circuit.

What is claimed is:

1. A computer implemented method for managing a storage array using simulation, comprising:
generating a virtual storage array, including a plurality of virtual storage array objects, associated with a physical storage array using a storage array simulator residing in a storage array management server;
performing configuration changes on the virtual storage array to form a desired virtual storage array to simulate presence of changed storage array without underlying hardware using the storage array simulator;
determining performance of the formed desired virtual storage array without the underlying hardware of the storage array using the storage array simulator; and
uploading the desired virtual storage array including the plurality of virtual storage array objects to the associated physical storage array based on the outcome of the determination.

2. The computer implemented method of claim 1, wherein the storage array is a storage area network (SAN) array.

3. The computer implemented method of claim 1, wherein generating the virtual storage array including the plurality of virtual storage array objects associated with the physical storage array comprises:
generating a data representation of the virtual storage array including the plurality of virtual storage array objects using the storage array simulator.

4. The computer implemented method of claim 3, wherein generating the data representation of the virtual storage array including the plurality of virtual storage array objects comprises:
extracting metadata associated with configuration information of the physical storage array, wherein the configuration information includes information selected from the group consisting of physical configuration information, virtual configuration information, utilization information, and synchronous/asynchronous mirroring information.

5. The computer implemented method of claim 4, wherein the metadata is in an XML format.

6. The computer implemented method of claim 5, wherein extracting the metadata associated with the configuration information of the physical storage array comprises:
extracting the metadata associated with the configuration information of the physical storage array in the XML format; and
loading up the metadata in the XML format and presenting the metadata in the XML format as the virtual storage array on a display device by the storage array simulator.

7. The computer implemented method of claim 5, wherein performing the configuration changes on the virtual storage array to form the desired virtual storage array comprises:
performing configuration changes on the metadata in the XML format associated with the virtual storage array to form the desired virtual storage array using the storage array simulator.

8. The computer implemented method of claim 7, wherein determining the performance of the formed desired virtual storage array without the underlying hardware of the storage array using the storage array simulator comprises:
performing a trend analysis on the formed desired virtual storage array without the underlying hardware of the storage array using the storage array simulator;
if needed, performing further configuration changes on the metadata in the XML format of the formed desired virtual storage array using the storage array simulator based on the outcome of the performed trend analysis; and
repeating steps of performing the trend analysis and performing the further configuration changes on the metadata in the XML format until the desired virtual storage array is formed.

9. The computer implemented method of claim 8, wherein uploading the desired virtual storage array including the plurality of virtual storage array objects to the associated physical storage array comprises:
generating a set of ordered physical storage array specific commands that can be executed by a storage management software managing the physical storage array using the metadata in the XML format of the desired virtual storage array using the storage array simulator; and
uploading the generated set of ordered physical storage array specific commands to the physical storage array by the storage array simulator.

10. A system for managing a storage array using simulation, comprising:
one or more storage arrays;
a storage array simulator residing in a storage array management server, wherein the storage array simulator includes a performance analyzer, a configuration analyzer and an upload/download module, and wherein the storage array management server includes a display device; and
a TCP/IP network switch, wherein the one or more storage arrays and the storage array management server are coupled via the TCP/IP network switch, wherein the storage array simulator generates a virtual storage array, including a plurality of virtual storage array objects, associated with a physical storage array residing in the storage array management server, wherein the storage array simulator performs configuration changes on the virtual storage array using the display device to form a desired virtual storage array to simulate presence of changed one of the one or more storage arrays without underlying hardware using the configuration analyzer residing in the storage array simulator, wherein the storage array simulator determines performance of the formed desired virtual storage array without the underlying hardware of the associated storage array using the performance analyzer residing in the storage array simulator, and wherein the storage array simulator uploads the desired virtual storage array including the plurality of virtual storage array objects to the associated physical storage array based on the outcome of the determination using the upload/download module residing in the storage array simulator.

11. The system of claim 10, wherein the one or more storage arrays are one or more SAN arrays, and wherein each SAN array includes a plurality of disk arrays, storage array controllers, I/O interfaces and one or more add-on trays.

12. The system of claim 10, wherein the storage array simulator generates a data representation of the virtual storage array including the plurality of virtual storage array objects.

13. The system of claim 12, wherein the storage array simulator extracts metadata associated with configuration information of the physical storage array, wherein the configuration information includes information selected from the group consisting of physical configuration information, virtual configuration information, utilization information, and synchronous/asynchronous mirroring information.

14. The system of claim 13, wherein the metadata is in an XML format.

15. The system of claim 14, wherein the storage array simulator extracts the metadata associated with the configuration information of the physical storage array in the XML format, and wherein the upload/download module residing in the storage array simulator loads up the metadata in the XML format and presents the metadata in the XML format as the virtual storage array on the display device.

16. The system of claim 15, wherein the storage array simulator performs configuration changes on the metadata in the XML format associated with the virtual storage array to form the desired virtual storage array using the configuration analyzer residing in the storage array simulator.

17. The system of claim 16, wherein the storage array simulator performs a trend analysis on the formed desired virtual storage array without the underlying hardware of the associated storage array using the performance analyzer residing in the storage array simulator, wherein the storage array simulator, if needed, performs further configuration changes on the metadata in the XML format of the formed desired virtual storage array using the performance analyzer residing in the storage array simulator based on the outcome of the performed trend analysis, and wherein the storage array simulator repeats the trend analysis and performs further configuration changes on the metadata in the XML format until the desired virtual storage array is obtained using the performance analyzer residing in the storage array simulator.

18. The system of claim 17, wherein the storage array simulator generates a set of ordered physical storage array specific commands that can be executed by a storage management software managing the physical storage array using the metadata in the XML format of the desired virtual storage array, and wherein the storage array simulator uploads the generated set of ordered physical storage array specific commands to the physical storage array using the upload/download module residing in the storage array simulator.

19. The system of claim 18, further comprising:
one or more application servers coupled to the one or more storage arrays via a cloud computing network and the TCP/IP network switch, wherein using the storage array simulators residing in one or more application servers associated with the cloud computing network to determine whether the uploaded generated set of ordered physical storage array specific commands associated with the formed desired virtual storage array in the associated one of the one or more physical storage arrays is provisioned to their requirements.

20. A non-transitory computer-readable storage medium for managing a storage array using simulation, having instructions that, when executed by a computing device cause the computing device to:
generate a virtual storage array, including a plurality of virtual storage array objects, associated with a physical storage array using a storage array simulator residing in a storage array management server;
perform configuration changes on the virtual storage array to form a desired virtual storage array to simulate presence of changed storage array without underlying hardware using the storage array simulator;
determine performance of the formed desired virtual storage array without the underlying hardware of the storage array using the storage array simulator; and
upload the desired virtual storage array including the plurality of virtual storage array objects to the associated physical storage array based on the outcome of the determination.
